(19) United States
(12) Patent Application Publication
(10) Pub. No.: US 2026/0176489 A1
(43) Pub. Date: Jun. 25, 2026

(54) Coatings And Multilayer Structures Using The Same For Passive Water Management

(71) Applicant: Adept Materials, Inc., Somerville, MA (US)

(72) Inventors: Derek Martin Stein, Providence, RI (US); Ilya Rushkin, Acton, MA (US); Jocelyn Lake, Tulsa, OK (US); Doycho Karagyozov, Somerville, MA (US)

(21) Appl. No.: 19/545,290

(22) Filed: Feb. 20, 2026

Related U.S. Application Data
(63) Continuation of application No. PCT/US24/43761, filed on Aug. 23, 2024.
(60) Provisional application No. 63/534,235, filed on Aug. 23, 2023.

(51) Int. Cl. C09D 129/04; C09D 7/63; C09D 133/02; C09D 139/02; D06N 3/00; D06N 3/04; D21H 19/12; E04B 1/62

(52) U.S. Cl. CPC C09D 129/04; C09D 7/63; C09D 133/02; C09D 139/02; D06N 3/0011; D06N 3/042; D21H 19/12; E04B 1/62; D06N 2201/0218; D06N 2209/123; D06N 2209/125; D06N 2211/06

(57) ABSTRACT

A structure for building applications, and method of making the same is provided. The structure can include a substrate layer having a first surface and a second, opposing surface and a cross-linked coat layer deposited on at least a portion of the first surface of the substrate layer. The cross-linked coat layer can include a mixture of polyvinyl alcohol and polycarboxylic acid. The multilayer structure can be configured to promote egress of water vapor in a first direction from the cross-linked coat layer to the substrate layer when the relative humidity is greater adjacent the cross-linked coat layer than adjacent the substrate layer and configured to inhibit ingress of water vapor in a second direction from the substrate layer to the cross-linked coat layer when the relative humidity is greater adjacent the substrate layer than adjacent the cross-linked coat layer.

### CROSS-REFERENCE TO RELATED APPLICATION

This application claims priority to U.S. Provisional Patent Application No. 63/534,235 filed on Aug. 23, 2023 and entitled “MULTILAYER STRUCTURES AND COATINGS FOR BUILDING APPLICATIONS,” the disclosure of which is incorporated herein by reference in its entirety.

### TECHNICAL FIELD

The subject matter described herein relates to coatings and multilayer structures for passive water management, e.g., in building applications.

### BACKGROUND

The purpose of a wall assembly is to provide an environment inside a building where occupants are comfortable and safe. Significant effort has been devoted to developing construction materials and assemblies that effectively regulate the temperature and relative humidity of the interior environment under varied exterior environmental conditions and interior use cases. A desired goal is to maintain the interior temperature and relative humidity within established ranges for human comfort and health with minimal inputs of energy from the HVAC system. A trend in construction has been toward building materials and assemblies thereof to trap air and heat more effectively to increase the thermal efficiency of the building. However, materials that effectively trap air and heat tend to also trap moisture within them, and in many situations building materials and assemblies create a risk of fungal growth and other forms of moisture damage by trapping excessive moisture and water vapor inside of the wall assembly.

Accordingly, there remains a need for improved materials to regulate the transport of water, e.g., water vapor, in and out of wall assemblies in order to maintain comfortable conditions inside the building and low risk of moisture damage to the building.

### SUMMARY

In certain implementations of the current subject matter, challenges associated with moisture regulation in buildings can be addressed by inclusion of one or more of the features described herein or comparable/equivalent approaches as would be understood by one of ordinary skill in the art. Implementations of the current subject matter relate to coatings and multilayer structures that provide water regulating capabilities, e.g., in building applications.

In some implementations, one or more of the following features may optionally be included in any feasible combination.

In one implementation, a multilayer structure for passive water management is provided. The multilayer structure includes a substrate layer having a first surface and a second, opposing surface and a cross-linked coat layer deposited on at least a portion of the first surface of the substrate layer, the cross-linked coat layer can include a mixture of polyvinyl alcohol and polycarboxylic acid, wherein the cross-linked coat layer has an first dry coat weight, and wherein, after the first cross-linked coat layer is exposed to water, the cross-linked coat layer has a second dry coat weight greater than 90% of the first dry coat weight. The multilayer structure is arranged to promote egress of water vapor in a first direction from the cross-linked coat layer to the substrate layer when the relative humidity is greater adjacent the cross-linked coat layer than adjacent the substrate layer. The multilayer structure is also arranged to inhibit ingress of water vapor in a second direction from the substrate layer to the cross-linked coat layer when the relative humidity is greater adjacent the substrate layer than adjacent the cross-linked coat layer, and. The multilayer structure has a first wet-cup permeance in the first direction and has a second wet-cup permeance in the second direction, the first wet-cup permeance being greater than second wet-cup permeance.

In some implementations, the polyvinyl alcohol can include polyvinyl alcohol copolymers.

In some implementations, the polycarboxylic acid can include one or more polycarboxylic acid copolymers. In some implementations, the polycarboxylic acid can include polyacrylic acid. In some implementations, the polyacrylic acid can include one or more polyacrylic acid copolymers. In some implementations, the polycarboxylic acid can include polymaleic acid. In some implementations, the polymaelic acid can include one or more polymaelic acid copolymers.

In some implementations, the first dry coat weight can be from about 3 gsm to about 50 gsm. In some implementations, the first dry coat weight can be 10 gsm.

In some implementations, the first wet-cup permeance can be at least 30 US perms. In some implementations, the second wet-cup permeance can be at most 30 US perms. In some implementations, a ratio of the first wet-cup permeance to the second wet-cup permeance can be about 3:2. In some implementations, a ratio of the first wet-cup permeance to the second wet-cup permeance can be about 2:1.

In some implementations, the multilayer structure can have a dry-cup permeance from about 0.1 US perms to 10 US perms. In some implementations, the multilayer structure can have a dry-cup permeance from about 1 US perms to 10 US perms. In some implementations, the cross-linked coat layer further can include at least one of one or more fillers, one or more pigments, or one or more pigment extenders. In some implementations, the cross-linked coat layer further can include one or more crosslinking agents, one or more cross-linking catalysts, or both.

In some implementations, the cross-linked coat layer can further include one or more plasticizers.

In some implementations, the substrate layer includes a desiccant material. In some implementations, the substrate layer does not include a desiccant material. In some implementations, the substrate layer can include gypsum. In some implementations, the substrate layer can include a non-woven high-density polyethylene (HDPE). In some implementations, the substrate layer can include open-cell insulation foam. In some implementations, the substrate layer can include batt insulation or insulation panels. In some implementations, the substrate layer can include a water resistive barrier film. In some implementations, the substrate layer can include magnesium oxide. In some implementations, the substrate layer can include cement. In some implementations, the substrate layer can include engineered wood. In some implementations, the substrate layer can include paper. In some implementations, the substrate layer can include wood fiber insulation.

In some implementations, the polyvinyl alcohol and polycarboxylic acid can be present within the mixture at a ratio of polyvinyl alcohol to polycarboxylic acid of about 20:1 about 10:1, about 4:1, about 2:1, about 3:2, about 1:1, about 2:3, about 1:2, about 1:4, about 1:10, or about 1:20.

In another implementation, a method of creating a multilayer structure according to the subject matter described herein is provided. The method includes providing a substrate layer having a first surface and a second surface that is opposite the first surface, depositing a coating composition on at least a portion of the first surface of the substrate layer, the coating composition including a carrier, polyvinyl alcohol, and polycarboxylic acid, the carrier including water and heating the coating composition to produce a cross-linked coat layer on the first surface of the substrate layer. The cross-linked coat layer has an first dry coat weight, and wherein, after the cross-linked coat layer is exposed to water, the cross-linked coat layer has a second dry coat weight greater than 90% of the first dry coat weight. The multilayer structure is arranged to promote egress of water vapor in a first direction from the cross-linked coat layer to the substrate layer when the relative humidity is greater adjacent the cross-linked coat layer than adjacent the substrate layer. The multilayer structure is arranged to inhibit ingress of water vapor in a second direction from the substrate layer to the cross-linked coat layer when the relative humidity is greater adjacent the substrate layer than adjacent the cross-linked coat layer, wherein the multilayer structure has a first wet-cup permeance in the first direction and has a second wet-cup permeance in the second direction, the first wet-cup permeance being greater than second wet-cup permeance.

In some implementations, heating the coating composition can include heating the coating composition at a temperature between 100 degrees C. and 120 degrees C. In some implementations, the coating composition can be heated for 24 hours.

In some implementations, the polyvinyl alcohol can include polyvinyl alcohol copolymers.

In some implementations, the polycarboxylic acid can include one or more polycarboxylic acid copolymers. In some implementations, the polycarboxylic acid can include polyacrylic acid. In some implementations, the polyacrylic acid can include one or more polyacrylic acid copolymers. In some implementations, the polycarboxylic acid can include polymaleic acid. In some implementations, the polymaelic acid can include one or more the polymaelic acid copolymers.

In some implementations, the first dry coat weight can be from about 3 gsm to 50 gsm. In some implementations, the first dry coat weight can be about 10 gsm.

In some implementations, the first wet-cup permeance can be at least 30 US perms. In some implementations, the second wet-cup permeance can be at most 30 US perms. In some implementations, a ratio of the first wet-cup permeance to the second wet-cup permeance can be about 3:2. In some implementations, a ratio of the first wet-cup permeance to the second wet-cup permeance can be about 2:1.

In some implementations, the multilayer structure can have a dry-cup permeance from about 0.1 US perms to 10 US perms. In some implementations, the multilayer structure can have a dry-cup permeance from about 1 US perms to 10 US perms. In some implementations, the cross-linked coat layer further can include at least one of one or more fillers, one or more pigments, or one or more pigment extenders. In some implementations, the cross-linked coat layer further can include one or more crosslinking agents, one or more cross-linking catalysts, or both.

In some implementations, the substrate layer can include a desiccant material. In some implementations, the substrate layer does not include a desiccant material. In some implementations, the substrate layer can include gypsum. In some implementations, the substrate layer can include a non-woven high-density polyethylene (HDPE) film. In some implementations, the substrate layer can include open-cell insulation foam. In some implementations, the substrate layer can include faced insulation batts or insulation panels. In some implementations, the substrate layer can include a water resistive barrier film. In some implementations, the substrate layer can include magnesium oxide. In some implementations, the substrate layer can include cement. In some implementations, the substrate layer can include engineered wood. In some implementations, the substrate layer can include paper. In some implementations, the substrate layer can include wood fiber insulation.

In some implementations, the polyvinyl alcohol and polycarboxylic acid can be present within the mixture at a ratio of polyvinyl alcohol to polycarboxylic acid of about 20:1 about 10:1, about 4:1, about 2:1, about 3:2, about 1:1, about 2:3, about 1:2, about 1:4, about 1:10, or about 1:20.

In another implementation, a wall assembly having passive water management capabilities is provided. The wall structure includes a wall frame having a cavity defined therein and one or more multilayer structures as described above. In this case, a first multilayer structure of the one or more multilayer structures can be disposed on a first face of the wall frame.

In some implementations, the cross-linked layer of the first multilayer structure can be positioned proximate to the cavity and the substrate layer of the first multilayer structure can be positioned distal to the cavity.

In some implementations, a surface of the substrate layer of the first multilayer structure can be a first exterior-most surface of the wall assembly.

In some implementations, a second multilayer structure of the one or more multilayer structures can be disposed on a second face of the wall frame, and wherein the second face opposes the first face of the wall frame.

In some implementations, the cross-linked layer of the second multilayer structure can be positioned proximate to the cavity and the substrate layer of the second multilayer structure can be positioned distal to the cavity.

In some implementations, a surface of the substrate layer of the second multilayer structure can be a second exterior-most surface of the wall assembly.

In some implementations, the cavity can include the one or more of insulation, air sealing materials, structural elements, acoustic absorbers, waterproofing materials, and air.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### BRIEF DESCRIPTION OF THE DRAWINGS

The accompanying drawings, which are incorporated into and constitute a part of this specification, show certain implementations of the subject matter disclosed herein and, together with the description, help explain some of the principles associated with the disclosed implementations. In the drawings:

FIG. 1 is a cross-sectional view of an exemplary multilayer structure, consistent with the implementations of the current subject matter;

FIG. 2 is a cross-sectional view of an exemplary wall assembly, consistent with the implementations of the current subject matter;

FIG. 3 is a cross-sectional view of another exemplary wall assembly, consistent with the implementations of the current subject matter;

FIG. 4 is a cross-sectional view of another exemplary wall assembly, consistent with the implementations of the current subject matter; and

FIG. 5 is a flow chart illustrating an exemplary method of making a multilayer structure, consistent with the implementations of the current subject matter.

It is noted that the drawings are not necessarily to scale. The drawings are intended to depict only typical implementations of the subject matter disclosed herein, and therefore should not be considered as limiting the scope of the disclosure. When practical, similar reference numbers denote similar structures, features, or elements.

### DETAILED DESCRIPTION

Conventional building materials and assemblies thereof are currently designed to trap air and heat to increase the thermal efficiency of the building. While these materials/assemblies effectively trap air and heat from traveling through the materials/assemblies, they also tend to trap moisture, which can lead to fungal growth and other forms of moisture damage by trapping excessive moisture and water vapor inside the wall assembly. For example, the vapor produced by the occupants and activities inside a home can be trapped by a construction material with good vapor barrier properties located in a wall assembly, which can lead to condensation or to the relative humidity inside the wall assembly rising above the threshold for mold growth, which is usually about 80%. Further, water vapor can diffuse into a building from the exterior environment and condense or become trapped inside the wall assembly. Yet another problem is that water vapor diffusing into a building from the outside (e.g., ambient environment) adds to the latent heat load that the HVAC system of a building needs to manage.

Accordingly, it is desirable for building materials that are used in walls of buildings to have a permeance that is above 10 U.S. Perms (e.g., above 30 U.S. Perms) when a relative humidity inside the wall assembly is 80% or greater so that the building materials can dry quickly. It is also desirable for building materials that are used in walls of buildings to have a permeance that is lower than in the previous situation when a relative humidity outside the wall assembly is 80% or greater so that the building materials accumulate water slowly when the vapor drive directs diffusive transport toward the interior of the wall assembly. It is also desirable for the vapor permeability of building materials used in walls of buildings to be below 10 U.S. Perms when the relative humidity on either side of the wall is 60% or lower in order to restrict water vapor from diffusing from a warmer side of the wall (e.g., typically the outside during the summer and the inside during the winter) to the colder side. However, conventional building materials tend to exhibit the same vapor permeance in both directions (e.g., into and out of a wall of a building) regardless of a direction of the vapor drive. Accordingly, these materials are not adequately capable of responding to changes in relative humidity on opposing sides of the walls to which they are applied. The permeance properties of many conventional building materials, including gypsum wallboard, nonwoven high-density polyethylene (HPDE) used as water-resistive barrier (WRB) film, open-cell foam insulation, paper, and batt insulation, are associated with a porous structure through which water vapor diffuses quickly and without regard to the direction of water vapor diffusion. The permeance of these materials are not heavily dependent on humidity because the vapor permeability of the air-filling pores of these materials remains relatively constant.

Additionally, building codes, such as the International Building Code (IBC), have set restrictive standards on the types of materials that can be used in building applications. For example, the IBS separates vapor barrier materials into three classes: Class I, II, and III, which are defined are as follows: Class I materials have a permeance less than or equal to 0.1 perms (E.g., polyethylene membrane or aluminum foil). Class II materials have a permeance between 0.1 and 1 perms (e.g., Kraft-faced insulation). Class III materials have a permeance between 1 and 10 perms (e.g., certain latex or enamel paints). Conventionally, Class I and II vapor retarders are too impermeable for most construction applications in the United States. Additionally, while Class III vapor retarders are most desirable for construction applications, achieving permeance characteristics for materials in the Class III range can be challenging, as most films that are used for vapor control in buildings, such as those that include polyethylene and polyamide, are also too impermeable.

Therefore, there is a need for improved building materials that are capable of adequately achieving variable vapor permeance through the materials, as a function of relative humidity on both sides of the materials, while satisfying the restrictive standards set forth above.

Generally, the process of cross-linking polymers tends to reduce the humidity-dependence of the vapor permeance of polymer films because it restricts the mobility of the polymer chains. However, the cross-linked coat layers described herein have been unexpectedly found to have improved and variable vapor permeability for construction materials that allows the materials to regulate the transport of water vapor in and out of the wall assembly in order for the building to maintain comfortable interior conditions and low risk of moisture damage to the building. The cross-linked coat layers described herein provide building materials that can exhibit improved water resistance, highly humidity-dependent and directional water vapor permeance that remain compliant with building codes, reduced costs as a result of low coat weights and simplistic manufacturing methods, and improved adhesion which allows the coating compositions to be easily applied to existing building materials. While the cross-linked coat layers are described herein with respect to building applications, it is also contemplated herein that such cross-linked coat layers are applicable to materials where water vapor regulation and control is desired, e.g., packaging materials for food, medical equipment, and consumer goods; containers for the shipping and storage of goods; clothing including high performance outerwear, personal protective equipment, and medical gowns

By providing vapor barrier properties that change as a function of the relative humidity and the direction of the vapor drive, the cross-linked coat layers described herein are valuable for satisfying the conflicting requirements of managing vapor transport under changing conditions. Furthermore, the coating compositions described herein can be easily applied to existing building materials in low coat weights and at low costs, which allows for builders to continue to employ established construction practices with familiar construction materials such that their workflow is not disrupted.

Certain exemplary implementations will now be described to provide an overall understanding of the principles of the structure, function, manufacture, and use of the cross-linked coat layers, multilayer structures, and methods disclosed herein. One or more examples of these implementations are illustrated in the accompanying drawings. Those skilled in the art will understand that the coating compositions, multilayer structures, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present disclosure.

In general, coating compositions are provided that include at least a carrier (e.g., water), polyvinyl alcohol, and polycarboxylic acid. Any one or more of these coating compositions are applied to at least one surface of a substrate (also referred to herein as substrate layer) and then dried to produce a multilayer structure. As such, the multilayer structures described herein include a cross-linked coat layer on a substrate. As described in more detail below, the multilayer structure disclosed herein are arranged to variously inhibit/promote the ingress/egress of water through the multilayer structures, based on the compositional makeup of the cross-linked coat layers, as the relative humidity adjacent respective opposing surfaces of the multilayer structures varies.

In general, the cross-linked coat layer includes a mixture of a mixture of polyvinyl alcohol and polycarboxylic acid.

In some implementations, the polyvinyl alcohol and polycarboxylic acid can be present within the mixture at a ratio of polyvinyl alcohol to polycarboxylic acid, in which the ratio can be about 20:1 about 10:1, about 4:1, about 2:1, about 3:2, about 1:1, about 2:3, about 1:2, about 1:4, about 1:10, or about 1:20. In certain implementations, the relative amounts of polyvinyl alcohol (PVA) or polyvinyl alcohol (PVA) copolymers to polycarboxilic acid within the mixture can range from 10% to 90% to 90% to 10%. In one implementation, the ratio of PVA to polycarboxilic acid can be from 50% to 50% (50/50) to 25% to 75% (25/75).

In some implementation, the polyvinyl alcohol can include polyvinyl alcohol copolymers.

Non-limiting examples of polycarboxilic acid can include polyacrylic acid and polyacrylic acid copolymers, polymethacrylic acid and polymethacrylic acid copolymers, polymaleic acid and polymaleic acid copolymers, polyitaconic acid and polyitaconic acid copolymers, or polyfumaric acid or polyfumaric acid copolymers. In certain implementations, the polycarboxilic acid can be polyacrylic acid with weight average molecular weight of about 250,000 Da.

In some implementations, the polycarboxylic acid can include one or more polycarboxylic acid copolymers. In one implementation, the polycarboxylic acid can include polyacrylic acid, polymaleic acid, or both. In certain implementations, the polyacrylic acid can include one or more polyacrylic acid copolymers. Alternatively, or in addition, the polymaelic acid can include one or more polymaelic acid copolymers.

In some implementations, the mixture can include polyvinyl alcohol (PVA) and polyacrylic acid (PAA). In some implementations, the mixture can include a dry weight ratio of PVA to PAA of about 20:1 about 10:1, about 4:1, about 2:1, about 3:2, about 1:1, about 2:3, about 1:2, about 1:4, about 1:10, or about 1:20. In some implementations, ranges for the PVA and PAA ratio of the cross-linked coat layer can include 75%-25% to 25%-75%, respectively, 60%-40% to 40%-60%, respectively and 45%-55% to 55%-45%, respectively. In some implementations, a degree of hydrolysis of the PVA's of the cross-linked coat layer can be between 80% and 99%.

In some implementations, the coating can include PVA copolymers. In some implementations, the PVA copolymers can include, but are not limited to Poly (ethylene vinyl alcohol), Polyvinyl Alcohol/Vinyl Amine Copolymer, Polyvinyl Alcohol/Vinyl Pyrrolidone Copolymer, Polyvinyl Alcohol/Vinyl Formamide Copolymer.

In some implementations, the PVA component of the coating can have a viscosity of 4-5 cps (4% aqueous solution, used as a measure of molecular weight) and degree of hydrolysis is between 97% and 99%. In another implementation the PVA component of the cross-linked coat layer 120 includes Poly (ethylene vinyl alcohol) which has viscosity of 12-30 cps (4% aqueous solution, used as a measure of molecular weight) and degree of hydrolysis between 97.5% and 99%. In another implementation the PVA component of the coating composition includes Poly (ethylene vinyl alcohol) which has viscosity of 12-16 cps (4% aqueous solution, used as a measure of molecular weight) and degree of hydrolysis <98%.

For example, in some implementations, the cross-linked coat layer can include 50% (dry wt) PVA which has viscosity of 4-5 cps (4% aqueous solution, used as a measure of molecular weight) and degree of hydrolysis is between 97% and 99% and 50% (dry wt) polyacrylic acid with weight average molecular weight of about 250,000 Da. In another implementation, the cross-linked coat layer can include 50% (dry wt) Polyvinyl Alcohol/Vinyl Formamide Copolymer which has viscosity of 5-10 cps (4% aqueous solution, used as a measure of molecular weight) and degree of hydrolysis <98% and 50% (dry wt) polyacrylic acid with weight average molecular weight of about 250,000 Da.

In some implementations, the cross-linked coat layer can further include crosslinking agents or crosslinking catalysts. Crosslinking agents are materials that react with components in the variable-permeability layer to improve mechanical and/or chemical properties such as water resistance. Non-limiting examples of suitable crosslinking agents can include ethanedial (Freechem 40 DL), polyamide-epichlorohydrin polymers (Polycup 172), epoxides, di- or polyisocyantates (Desmodur BL 3175), melamine-based crosslinkers such Cymel 303, glycoluril-based crosslinkers such as Cymel 1172 or copper complexes such as copper phthalocyanine. However other crosslinking agents can also be used. The amount of crosslinking agent that is included in the cross-linked coat layer can range between 0.5-20% from the total amount of the dry coating composition, the amount is 1-15% from the total amount of the dry coating composition. In some implementations, the crosslinking catalysts that can be used in the coating composition can be acids or acid salts that include any of p-tulune sulfonic acid or tertiary ammonium salts of p-toluene sulfonic acid. However other crosslinking catalysts can also be used. The amounts of catalyst that is included in the cross-linked coat layer can range between 0.5-3% from the total amount of the dry coating composition. In some implementations, the cross-linked coat layer can also include fillers, pigments and pigment extenders such as titanium dioxide, calcium carbonate, zinc oxide, nepheline syenite, clays such as bentonites, attapulgite clays (Attagel) or kaolin clay. The total combined amounts of fillers, pigments and pigment extenders can range between 0-70% (wt) from the total amount of the dry coating composition.

In some implementations, the cross-linked coat later can further include plasticizers. Plasticizers or plasticizing agents are materials that modify the flexibility of the coat layer. Examples of the plasticizers that can be used are phthalates such as di(2-ethylhexyl) phthalate, diisononyl phthalate, and diisodecyl phthalate, adipates such as dioctyl adipate, di(2-ethylhexyl) adipate, polyols such as glycerol and sorbitol. Other examples of plasticizers that can be used are trimellitates, dicarbonates, phosphates, and fatty acid esters.

In some implementations, a coating composition that includes 18% aqueous solution of 50% (dry wt) Polyvinyl Alcohol/Vinyl Formamide Copolymer, which has viscosity of 5-10 cps (4% aqueous solution, used as a measure of molecular weight) and degree of hydrolysis <98%, and 50% (dry wt) polyacrylic acid with weight average molecular weight of about 250,000 Da, can be prepared. This coating composition can then be coated on oxygen plasma treated non-woven HDPE and dried at 250° F. for 4 hrs. The resulting multilayer structure can have a dry cup permeability of 4.5 US Perms, wet cup permeability of 52 US Perms and no weight loss after being submerged in water for 1 hr. Adhesion failure after (5 mm cross-hatch)=0%.

Alternatively, or in addition, the coating composition can include one or more fillers, one or more pigments, one or more pigment extenders, or any combinations thereof.

The multilayer structures can be used in a wide variety of applications. For example, building applications, packaging materials for food, medical equipment, and consumer goods; containers for the shipping and storage of goods; clothing including high performance outerwear, personal protective equipment, and medical gowns.

In one exemplary implementation, a multilayer structure can include a substrate layer and a cross-linked coat layer, in which the substrate layer has a first surface and a second, opposing surface, and the cross-linked coat layer is deposited on at least a portion of the first surface of the substrate layer. In some implementations, the cross-linked coat layer can be deposited on the entire first surface of the substrate layer. The cross-linked coat layer includes a mixture of polyvinyl alcohol and polycarboxylic acid, in which the cross-linked coat layer has a first dry coat weight, and wherein, after the cross-linked coat layer is exposed to water (e.g., submerged in water for about 1 hour, as described in greater detail in the examples provided below), the cross-linked coat layer has a second dry coat weight greater than 90% of the first dry coat weight. If the cross-linked coat layer is applied to a water-insoluble substrate such as polyethylene, the cross-linked coat layer can be exposed to water by submerging the entire structure in distilled water at room temperature for one hour, followed by dipping the structure in fresh distilled water ten times to rinse it, and then drying it in an oven at 60 degrees C. for 2 hours. The cross-linked coat layer can also be exposed to water by sealing one end of a plastic cylinder to it, placing the coating and cylinder horizontally such that the coated surface defines the base of an open basin, adding distilled water to the cylinder until the water surface rises at least 3 cm above the cross-linked coat layer, emptying the cylinder after one hour, rinsing the exposed surface with fresh distilled water, and then drying the structure in an oven at 60 degrees C. for 2 hours. The cross-linked coat layer is formed by depositing a coating composition (e.g., polyvinyl alcohol, polycarboxylic acid, and a carrier) onto at least a portion of the substrate layer and thereafter dried to remove the carrier. As such, the dry coat weight of the cross-linked coat layer is the weight of the dried coating composition after the carrier has evaporated. The dry coat weight can be measured by weighing a substrate, applying a coating composition on the substrate, drying the coating composition for about four hours in an oven held at temperature of about 60 degrees C., weighing the dry coated structure, and calculating the weight of the cross-linked coat layer.

The multilayer structures described herein can be configured to promote egress of water vapor in a first direction from the cross-linked coat layer to the substrate layer when the relative humidity is greater adjacent the cross-linked coat layer than adjacent the substrate layer, and the multilayer structure is configured to inhibit ingress of water vapor in a second direction from the substrate layer to the cross-linked coat layer when the relative humidity is greater adjacent the substrate layer than adjacent the cross-linked coat layer. Additionally, the multilayer structure has a first wet-cup permeance in the first direction and has a second wet-cup permeance in the second direction, the first wet-cup permeance being greater than second wet-cup permeance.

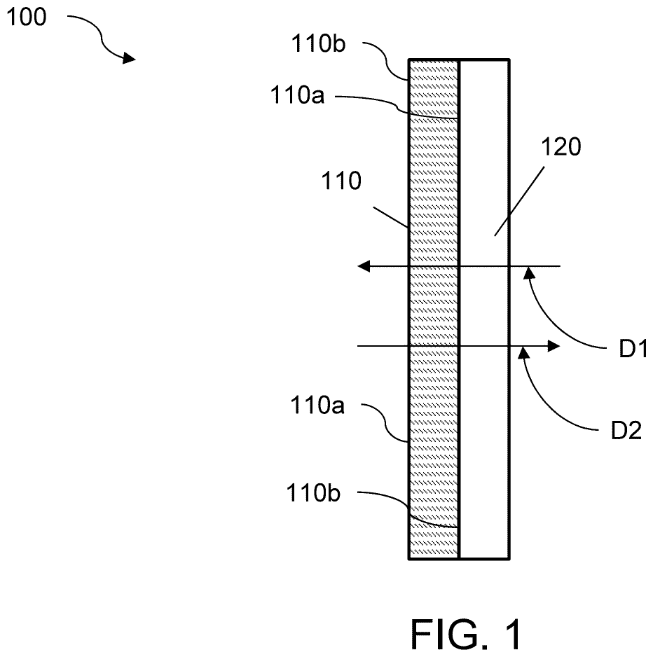

FIG. 1 is a cross-sectional view of an exemplary multilayer structure 100 that provides variable vapor barrier properties that change as a function of the relative humidity and the direction of the vapor drive. In some implementations, the multilayer structure 100 can include a substrate layer 110 having a first surface 110a and a second surface 110b and a cross-linked coat layer 120 deposited on a first surface of the substrate layer 110. implementation

In use, when the relative humidity is greater adjacent the cross-linked coat layer 120 than adjacent the substrate layer 110, the multilayer structure promotes egress of water vapor in a first direction D1 from the cross-linked coat layer 120 to the substrate layer 110. Further, when the relative humidity is greater adjacent the substrate layer than adjacent the cross-linked coat layer, the multilayer structure inhibits ingress of water vapor in a second direction D2 from the substrate layer 110 to the cross-linked coat layer 120. As such, the multilayer structure has a first wet-cup permeance in the first direction D1 and has a second wet-cup permeance in the second direction D2, in which the first wet-cup permeance is greater than second wet-cup permeance.

In some implementations, the first wet-cup permeance can be from about 10 to 200 US perms, from about 15 to 100 US perms, or from about 20 to 60 US perms. In one example of a cross-linked coat later applied with a 10 gsm dry coat weight to a half-inch thick gypsum panel, the first wet cup permeance is 41 US perms. It is also contemplated that the first wet-cup permeance does not fall outside any of these recited ranges. In some implementations, the first wet-cup permeance can be at least about 30 US perms.

Alternatively or in addition, the second wet-cup permeance can be from about 3 to 50 US perms, from about 5 to 30 US perms, or from about 8 to 25 US perms. It is also contemplated that the second wet-cup permeance does not fall outside any of these recited ranges. In some implementations, the second wet-cup permeance can be at most about 30 US perms. In the example of a cross-linked coat layer applied with a 10 gsm dry coat weight to a half-inch thick gypsum panel, where the first wet cup permeance is 41 US perms, the second wet cup permeance is about 23 US perms.

In some implementations, a ratio of the first wet-cup permeance to the second wet-cup permeance can be about 5:2. It is also contemplated that the ratio does not fall outside any of these recited ranges. In certain implementations, a ratio of the first wet-cup permeance to the second wet-cup permeance can be about 3:2. In one implementation, the ratio of the first wet-cup permeance to the second wet-cup permeance can be about 2:1.

In some implementations, the multilayer structure can have a dry-cup permeance from about 0.1 US perms to 10 US perms. It is also contemplated that the dry-cup permeance does not fall outside any of these recited ranges. In certain implementations the multilayer structure can have a dry cup permeance from about 0.1 US perms to 10 US perms, 0.5 to 8 US perms, 1 to 5 US perms. In one implementation, the multilayer structure can have a dry-cup permeance from about 1 US perms to 10 US perms.

The cross-linked coat layer has characteristics of a humidity dependent vapor retarder, in which its permeance increases as humidity rises. In a dry cup permeance test, the humidity is significantly lower (e.g., 10 times lower) than the permeance measured in a wet cup permeance test. Both a dry cup permeance and a wet cup permeance of the multilayer structure can be measured in accordance with ASTM E 96. More specifically, according to ASTM E 96a, dry cup permeance is measured using an average relative humidity (RH) of 25%, with the RH on one side of the multilayer structure at 0% and the RH on the other side of the multilayer structure at 50% at a temperature of 73° F. (23° C.), and according to ASTM E 96b, wet cup permeance is measured using an average RH of 75%, with the RH on one side of the multilayer structure at 50% and the RH on the other side of the multilayer structure at 100% at a temperature of 73° F. (23° C.).

In some implementations, the cross-linked coat layer can have an first dry coat weight, and after the first cross-linked coat layer is exposed to water, the cross-linked coat layer can have a second dry coat weight greater than the first dry coat weight. In some implementations, the first dry coat weight can be from about 3 gsm to 50 gsm, from about 5 gms to 20 gsm, or from about 8 gsm to 15 gsm. In one implementation, the second dry coat weight is greater than 90% of the first dry coat weight.

In some implementations, the first dry coat weight can be from about 3 gsm to about 50 gsm. In certain implementations, the first dry coat weight can be from about 5 gsm to 20 gsm or from about 8 gsm to 15 gsm. In one implementation, the first dry coat weight can be about 10 gsm.

The cross-linked coat layer 120 can be formed by applying a coating composition to at least a portion of the first surface 110a of the of the substrate layer 110 and thereafter cured (e.g., by heating). The coating composition can be applied to at least a portion of the first surface 110a of the substrate layer by rod coating, roll coating, spray coating, gravure coating, wire rod coating, knife coating, slot die coating, painting with brush or foam or microfiber roll, or any other suitable method of coating deposition. The coating composition can be any coating composition described herein.

The substrate layer 110 can be formed of a variety of suitable materials. Non-limiting examples of suitable materials can include gypsum, such as a gypsum panel, non-woven high-density polyethylene (HDPE), such as a HDPE film, open-cell insulation foam, faced insulation batt, water resistive barrier film, wood veneer, or paper. The faced insulation batt can include fiberglass, mineral wool, or natural fibers such as wood fiber, hemp, bamboo, and cellulose. Such materials do not regulate or can sufficiently regulate water transport, e.g., through wall assemblies in buildings. As such, by implementing the cross-linked coat layer 120 on the substrate layer 110, as shown in FIG. 1, the resulting multilayer structure 100 can have improved directional permeance characteristics relative to substrate layer by itself.

In some implementations, the substrate layer can include a desiccant material. Non-limiting examples of suitable desiccant materials can include silica gel (e.g., SYLOID® mesoporous silica products from W. R. Grace, including SYLOID® AL1), zeolites, molecular sieve, bentonite clay, aluminum oxide (activated alumina), calcium oxide, calcium sulfate, magnesium sulfate, magnesium chloride, metal-organic frameworks (MOFs) that have a high capacity to store water (for example, MIL-101, MOF-801, NU-1000, UiO-66, and NOTT-112), and the like, and any combination thereof. A material with a high capacity to store water can store at least 10% of its dry weight in water.

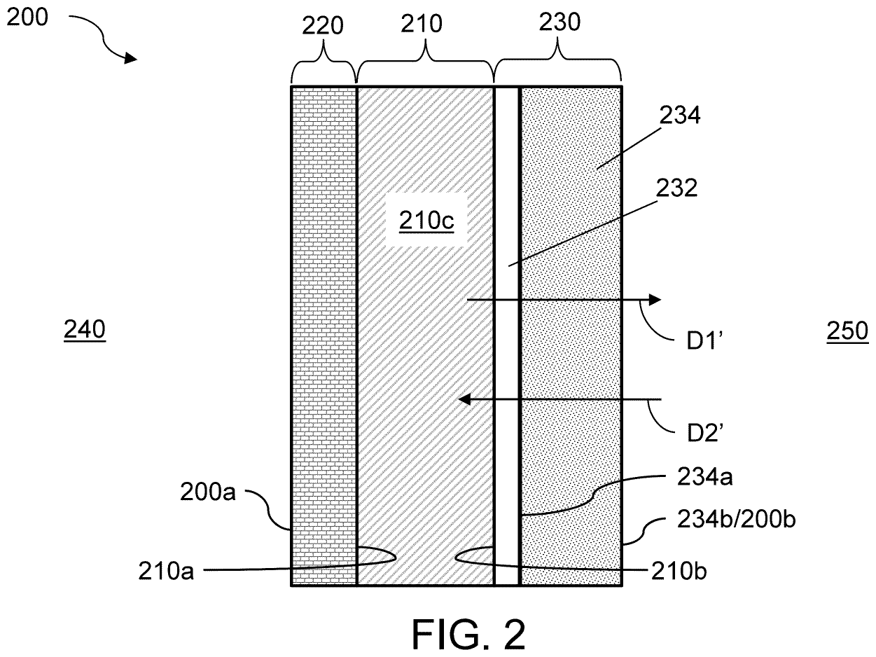

The multilayer structures described herein can be applied to a variety of structures, as described in greater detail below. For example, in some implementations, as shown in FIG. 2, a wall assembly 200 can include a wall frame 210 having a first face 210a, a second face 210b and a cavity 210c defined therein. In some implementations, the wall cavity 210c can comprise a variety of components/layers. For example, in some implementations, the wall cavity 210c can be comprised of one or more of insulation, air sealing materials, structural elements, acoustic absorbers, waterproofing materials, and air. The wall assembly 200 can also include a siding material 220 that can be applied to the first surface 210a of the wall frame 210, which can be configured to face an exterior environment 240. Accordingly, the siding material 220 can form a first exterior-most surface 200a of the wall assembly 200. The wall assembly 200 can also include a first multilayer structure 230 which can be disposed on the second face 210b of the wall frame 210, as shown in FIG. 2. The first multilayer structure 230 of the wall assembly 200 can be similar to the multilayer structure 100 of FIG. 1, and therefore common elements are not described in detail herein. In some implementations, the first multilayer structure 230 can be applied to the second face 210b of the wall frame 210 such that a cross-linked coat layer 232 of the first multilayer structure 230 is disposed adjacent to the second face 210b of the wall frame 210 and adjacent to a first face 234a of a substrate layer 234. A second face 234b of the substrate layer 234 of the first multilayer structure 230 can be disposed adjacent to an interior space 250. Accordingly, the second face 234b of the substrate layer 234 of the first multilayer structure 230 can form a second exterior-most surface 200b of the wall assembly 200.

In some implementations, for example, the substrate layer 234 can include (or not include) a desiccant material. In some implementations, the substrate layer 234 can be a gypsum wallboard, open-cell insulation foam, batt insulation, insulation panels, magnesium oxide, cement, engineered wood, paper, or wood fiber insulation, and the cross-linked coat layer 232 can similar to the cross-linked coat layers described above. In this case, when a humidity level of the exterior environment 240 is high, the multilayer structure 230 can be configured to allow for water vapor to diffuse relatively quickly through the second face 210b to the interior 250, in a direction D1′. This advantageously allows for a cavity of the wall to dry out quickly in response to moisture intrusion, a water leak, or the transport of water vapor into the wall cavity from the exterior 240 by diffusion or convection. Alternatively, in a case where the humidity level on the interior 250 is high, the multilayer structure 230 can be configured to allow for water vapor to diffuse relatively slowly through the multilayer structure 230 from the interior 250, through the second face 210b, into the wall cavity 210c, in a direction D2′. This advantageously allows for the accumulation of moisture inside the wall cavity 210c to be slowed. The ease with which water vapor escapes the wall cavity 210a (in the direction D1′) relative to the entry of water vapor (in the direction D2′) resists the accumulation of excess humidity and moisture in the wall cavity 210c, which protects it against mold, mildew, and other forms of moisture damage.

Additionally, the aforementioned humidity dependent vapor permeability of the multilayer structure 230 is also beneficial during periods of cold weather. For example, it is common for water vapor to diffuse from the interior of buildings to the exterior during periods of cold weather, which can condense on the cold side of the wall. By providing the multilayer structure 230 in a wall assembly 200, the low permeance characteristics of the multilayer structure 230 at low relative humidity levels will advantageously prevent water vapor from diffusing from the interior 250 toward the wall cavity 210c, in the direction D2′.

Alternatively, during periods of warm weather, it is common for humidity to accumulate at the exterior of the building, that can seep into the wall cavity. In this case, by providing the multilayer structure 230 in a wall assembly 200, the permeance characteristics of the multilayer structure 230 will increase to allow for water vapor that has accumulated in the wall cavity 210c to diffuse to the interior 250, in the direction D1′, thus advantageously preventing excess humidity and moisture from collecting inside the wall cavity 210c.

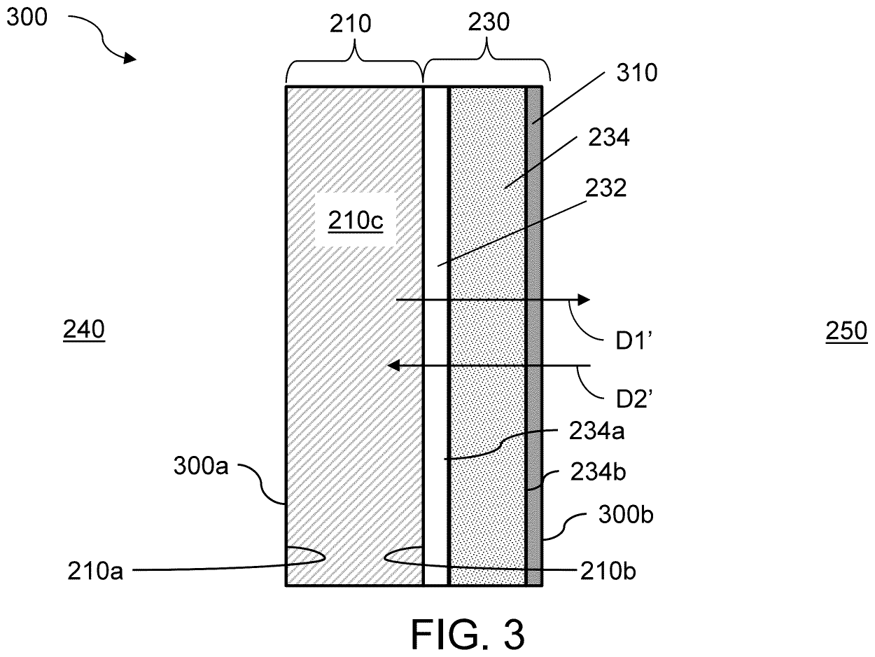

In another implementation, as shown in FIG. 3, a wall assembly 300 can include the wall frame 210 and the first multilayer structure 230 of FIG. 2, accordingly, common elements are not described in detail herein. In some implementations, the wall assembly 300 can further include a surface coating 310 (e.g., paint or wallpaper) which can be applied to the second face 234b of the substrate layer 234, such that the surface coating 310 forms a second exterior-most surface 300b of the wall assembly 300. It is also realized that the wall assembly 300 can also include the siding material 220, of FIG. 2, which can be applied to a first exterior-most surface 300a of the wall assembly 300, similarly to as described above. In the implementation of FIG. 3, the multilayer structure 230 of the wall assembly 300 can be configured to variously allow for water vapor to diffuse through the second face 210b of the wall frame 210, similarly to as described above in reference to FIG. 2.

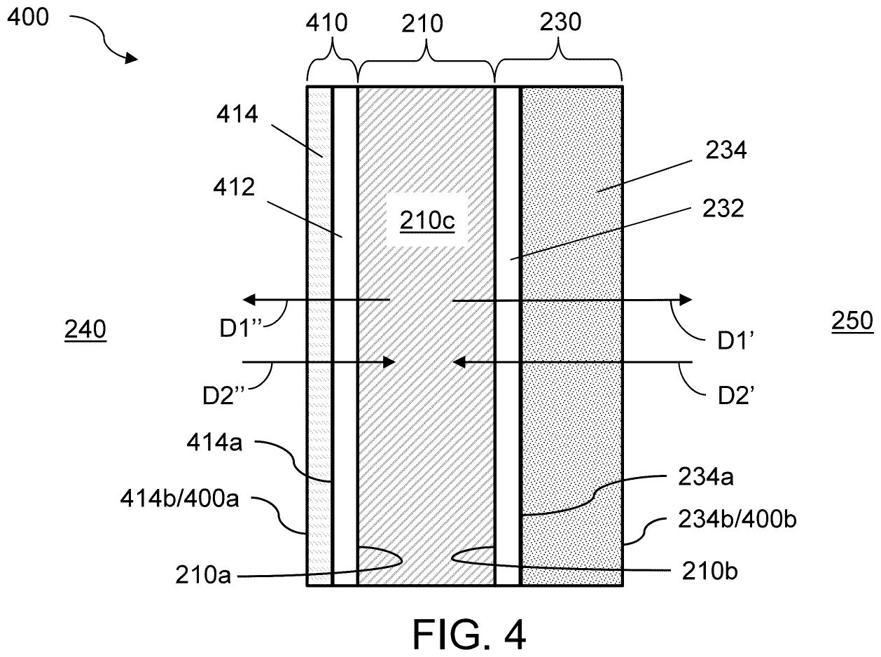

In another implementation, as shown in FIG. 4, a wall assembly 400 can include the wall frame 210 and the first multilayer structure 230 of FIG. 2, accordingly, common elements are not described in detail herein. In some implementations, the wall assembly 300 can further include a second multilayer structure 410 which can be applied to the first surface 210a of the wall frame 210, as shown in FIG. 4. The second multilayer structure 410 of the wall assembly 400 can be similar to the multilayer structure 100 of FIG. 1, and therefore common elements are not described in detail herein. In some implementations, the second multilayer structure 410 can be applied to the first face 210a of the wall frame 210 such that a cross-linked coat layer 412 of the second multilayer structure 410 is disposed adjacent to the first face 210a of the wall frame 210 and adjacent to a first face 414a of a substrate layer 234. A second face 414b of the substrate layer 414 of the second multilayer structure 414 can be disposed adjacent to the exterior environment 240. Accordingly, the second face 414b of the substrate layer 414 of the second multilayer structure 410 can form a first exterior-most surface 400a of the wall assembly 400 which can be configured to face the exterior environment 240. As described above, the second face 234b of the substrate layer 234 of the first multilayer structure 230 can be disposed adjacent to an interior space 250 such that it forms a second exterior-most surface 400b of the wall assembly 400. It is also realized that the wall assembly 400 can also include the siding material 220, of FIG. 2, which can be applied to the first exterior-most surface 400a of the wall assembly 400, similarly to as described above. It is also realized that the wall assembly 400 can also include the surface coating 310, of FIG. 3, which can be applied to the second face 234b of the substrate layer 234, such that the surface coating 310 forms the second exterior-most surface 400b of the wall assembly 400. In the implementation of FIG. 4, the first multilayer structure 230 of the wall assembly 400 can be configured to variously allow for water vapor to diffuse through the second face 210b of the wall frame 210, similarly to as described above in reference to FIG. 2.

In some implementations, for example, the substrate layer 414 can be a non-woven high-density polyethylene (HDPE), an insulation panel, a water resistive barrier film, magnesium oxide, cement, engineered wood, or wood fiber insulation, and the cross-linked coat layer 412 can similar to the cross-linked coat layers described above. In this illustrated implementation, when the relative humidity level of the interior 250 is higher compared to the relative humidity level of the exterior 240, the second multilayer structure 410 can be configured to allow water vapor to diffuse relatively quickly from the cavity 210c, through the first face 210a of the wall frame 210, in a direction D1″. This advantageously allows for the wall cavity 210c of the wall assembly 400 to dry out quickly in response to moisture intrusion, a water leak inside the wall assembly, the transport of water vapor into the wall assembly 400 from the interior 250 by diffusion or convection, etc. Additionally, when the relative humidity level of the exterior 240 is higher compared to the relative humidity level of the interior 250, the multilayer structure 410 can be configured to allow for water vapor to diffuse relatively slowly from the exterior 250, through the first face 210a of the wall frame 210, into the cavity 210c, in a direction D2″. This advantageously inhibits the accumulation of moisture inside the wall cavity 210c, while still allowing for any water vapor within the cavity 210c to diffuse in the direction D1″ relatively easily. Accordingly, by allowing water vapor to escape from cavity 210c to the exterior 240 relatively easily, while resisting water vapor from entering the cavity 210c from the exterior 240, the multilayer structure 410 is capable of preventing excess humidity and moisture from building up within the wall cavity 210c which prevents mold, mildew, and other forms of moisture damage.

Additionally, the aforementioned humidity dependent vapor permeability of the multilayer structure 410 is also beneficial when the relative humidity between the interior 250 and the exterior 240 is low, as it prevents water vapor from diffusing from the exterior 240 toward the interior 250, in the direction D2″ in warm weather. For example, it is common for water vapor to diffuse toward the interior of a building during periods of warm, humid weather, which can pose a risk of condensing on the interior wall of the building (e.g., the second exterior-most surface 400b of the wall assembly 400), especially if a temperature of the interior 250 is lower than a temperature at the exterior 240 (which is often the case during these periods, as the interior of the building is often air conditioned).

Further, during periods of cold weather, water vapor diffusing from a warm interior 250 toward the exterior 240 will raise the humidity adjacent the cross-linked coat layer 412 of the multilayer structure 410. When this is the case, the permeance of the multilayer structure 410 can be configured to increase, allowing the water vapor to escape the wall cavity 210c to the exterior 240, in the direction D1″, thus preventing excess humidity and moisture from collecting within the cavity 210c.

Furthermore, the directional and humidity-dependent vapor permeance of the multilayer structure 410 can also reduce an amount of energy that is required to perform dehumidification of the interior 250. For example, traditionally, during periods of hot, humid weather, water vapor will tend to diffuse through a wall assembly 400, from the exterior 240 to the interior 230, which will add to a latent heat load that a building's HVAC system needs to manage through dehumidification. However, by utilizing the multilayer structure 410, the diffusion of water vapor from the exterior 240 to the interior 250, in the direction D2″, is restricted, as described above, resulting in a lower latent heat load that the building's HVAC system needs to manage.

By utilizing both the first multilayer structure 230 and the second multilayer structure 410 in the wall assembly 400, the wall assembly 400 is able to effectively increase the rate at which vapor \ diffuses out of the wall cavity 210c in the directions D1′ and D1″ and decrease the rate at which vapor is diffused into the wall cavity 210c in the directions D2′ and D2″, thus preventing excess humidity and moisture from collecting within the cavity 210c. The rates D1′ and D2′ increase relative to the rates D2′ and D2″, respectively. The rates D2′ and D2″ decrease relative to the rates D1′ and D2″, respectively.

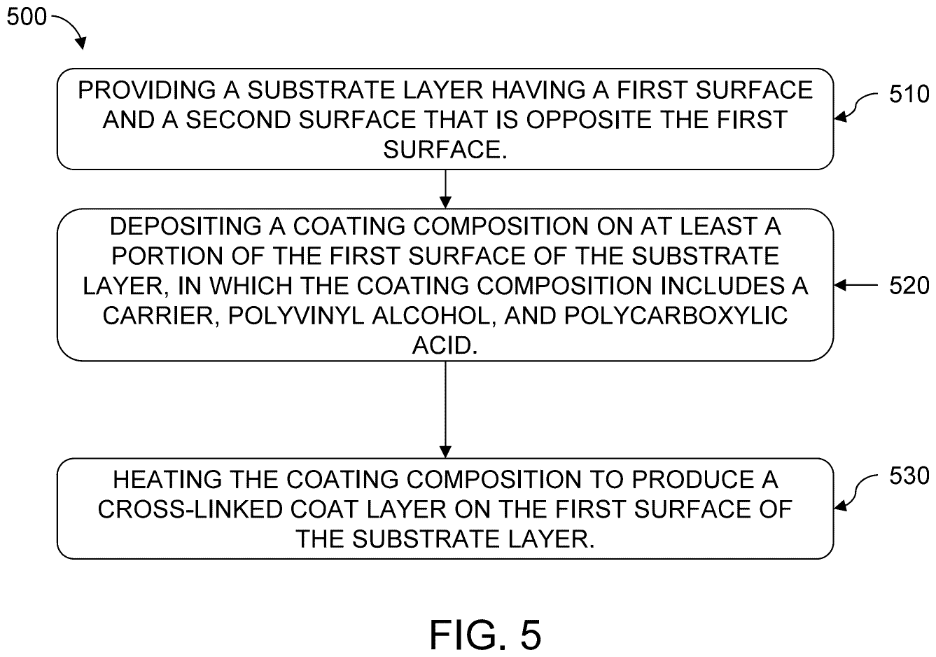

FIG. 5 is a diagram illustrating an exemplary method 500 of making various multilayer structures according to the subject matter described herein (e.g., multilayer structure 100 described above). In some implementations, the method 500 can include a step 510 of providing a substrate layer (e.g., substrate layer 110) having a first surface and a second surface that is opposite the first surface. In some implementations, the substrate layer includes a desiccant material. In some implementations, the substrate layer does not include a desiccant material. Additionally, in some implementations, the substrate layer can include one or more of gypsum (e.g., a gypsum wallboard), non-woven high-density polyethylene (HDPE) film, open-cell insulation foam, faced insulation batts or insulation panels, a water resistive barrier film, magnesium oxide, cement, engineered wood, paper, or wood fiber insulation.

The method 500 can also include a step 520 of depositing a coating composition on at least a portion of the first surface of the substrate layer. The coating composition includes a carrier, polyvinyl alcohol, and polycarboxylic acid. The carrier can be an aqueous solution. In some implementations, the carrier is water. In some implementations, the polyvinyl alcohol can include polyvinyl alcohol copolymers. In some implementations, the polycarboxylic acid can include one or more polycarboxylic acid copolymers. In some implementations, the polycarboxylic acid can include polyacrylic acid. In some implementations, the polyacrylic acid can include one or more polyacrylic acid copolymers. In some implementations, the polycarboxylic acid can include polymaleic acid. In some implementations, the polymaelic acid can include one or more the polymaelic acid copolymers. In some implementations, the first dry coat weight can be from about 3 gsm to about 50 gsm. Specifically, in some implementations, the first dry coat weight can be about 10 gsm. In some implementations, the polyvinyl alcohol and polycarboxylic acid can be present within the mixture at a ratio of polyvinyl alcohol to polycarboxylic acid of about 20:1 about 10:1, about 4:1, about 2:1, about 3:2, about 1:1, about 2:3, about 1:2, about 1:4, about 1:10, or about 1:20. In some implementations, the coating composition can be deposited on the substrate layer by any of spraying, roll coating, gravure coating, wire rod coating, knife coating, slot die coating or painting with brush or foam or microfiber roll or any other suitable method of coating deposition as described above.

The application method can depend on the material of the substrate layer and convenience. For example, at a job site application, the step 520 of depositing the coating composition can be done by spray coating or painting with brush or foam or microfiber roll. In another example, at a factory application, the step 520 of depositing the coating composition can be done with roll coating, gravure coating, wire rod coating or knife coating. In some implementations, the coating composition can be made by dispersing PVA or PVA copolymers in cold water using an electric stirrer or the like and a dispersant blade and heating the mixture to 90° C. under stirring until a clear solution is formed. In some implementations, adhesion of the coating formulation to the substrate layer during step 520 can be promoted by pre-treating the substrate layer such as nonwoven HDPE with an oxygen plasma.

The method 500 can also include a step 530 of heating the coating composition to produce a cross-linked coat layer on the first surface of the substrate layer. In some implementations, the step 530 of heating the coating can cause the coating to crosslink, thereby forming a water-stable coating without compromising the variable vapor permeability characteristics of the coating described above. In some implementations, the cross-linked coat layer can have an first dry coat weight, and after the cross-linked coat layer is exposed to water, the cross-linked coat layer can have a second dry coat weight greater than 90% of the first dry coat weight. In some implementations, the coating composition can be heated for 24 hours. In some implementations, after depositing the coating composition onto the substrate layer, the coating can be heated at a temperature between 100-120° C. For example, in a case where the substrate layer is a gypsum wallboard, the coating composition can be applied to the gypsum wallboard during a manufacturing process and the gypsum wallboard with the coating composition applied thereto can be heated at a temperature between 100-120° C. In some implementations, the cross-linked coat layer can also include one or more plasticizers.

In some implementations, the multilayer structure that is created by the method steps of method 500 can be configured to promote egress of water vapor in a first direction from the cross-linked coat layer to the substrate layer when the relative humidity is greater adjacent the cross-linked coat layer than adjacent the substrate layer and can be configured to inhibit ingress of water vapor in a second direction from the substrate layer to the cross-linked coat layer when the relative humidity is greater adjacent the substrate layer than adjacent the cross-linked coat layer. In some implementations, the multilayer structure that is created by the method steps of method 500 can have a first wet-cup permeance in the first direction and has a second wet-cup permeance in the second direction, the first wet-cup permeance being greater than second wet-cup permeance.

The coatings and multilayer structures may be further understood with the following non-limiting examples.

### EXAMPLES

### Example 1. Preparation of Samples (PVA or PVA Copolymers Stock Solutions)

PVA or PVA copolymer were dispersed in cold water using electric stirrer and dispersant blade. This dispersion was heated to 90° C. under stirring until a clear solution formed.

TABLE 1
Properties of PVA or PVA Co-Polymers in Formulation Samples

| Formulation | | Polymer viscosity | Hydrolysis |
|---|---|---|---|
| Sample | Materials | (4% solution, cP) | (%) |
| F-1 | PVA | 5-6 | 88 |
| F-2 | PVA | 5-6 | 98 |
| F-3 | Vinyl Amine Copolymer | 5-10 | 99 |
| F-4 | Vinyl Pyrrolidone | 5-10 | 99 |
| | Copolymer | | |
| F-5 | Vinyl Formamide | 5-10 | 99 |
| | Copolymer | | |
| F-6 | Ethylene Copolymer | 25-30 | 99 |
| F-7 | Ethylene Copolymer | 12-15 | 99 |

TABLE 2
Properties of Formulation Samples

| Formulation | % solids in |
|---|---|
| Sample | formulation |
| F-1 | 20 |
| F-2 | 20 |
| F-3 | 15 |
| F-4 | 10 |
| F-5 | 15 |
| F-6 | 10 |
| F-7 | 12 |

### Example 2. Preparation of Multilayer Structures

Kraft paper was coated with the Formulation Samples F1-F7 prepared in Example 1 using #25 wire rod and then dried overnight at room temperature. Dry coat weight of each of the coat layers (i.e., the dried formulations) was determined by punching 2.5″ circles of each coated kraft paper (i.e., each multilayer structure) using circle puncher (Fiskars) and the weight of 6 circles was then compared to the weight of 6 circles of uncoated Kraft paper. Water vapor permeability was determined according to ASTM E 96, in which dry cup permeance was determined according to ASTM-E 96a and wet cut permeance was determined according and ASTM-E 96b. More specifically, according to ASTM E 96a, dry cup permeance is measured using an average relative humidity (RH) of 25%, with the RH on one side of the multilayer structure at 0% and the RH on the other side of the multilayer structure at 50% at a temperature of 73° F. (23° C.), and according to ASTM E 96b, wet cup permeance is measured using an average RH of 75%, with the RH on one side of the multilayer structure at 50% and the RH on the other side of the multilayer structure at 100% at a temperature of 73° F. (23° C.).

TABLE 3
Coatings of Samples on Kraft paper

| | | Coat | Dry Cup | Wet Cup | Wet |
|---|---|---|---|---|---|
| Coat | Formulation | weight | Permeance | Permeance | Cup/Dry |
| layer | Sample | (gsm) | (US Perms) | (US Perms) | Cup ratio |
| C-1 | F-1 | 10 | 3 | 133 | 44 |
| C-2 | F-2 | 15 | 3 | 123 | 41 |
| C-3 | F-3 | 12.6 | 4 | 200 | 50 |
| C-4 | F-4 | 10.4 | 5 | 140 | 28 |
| C-5 | F-5 | 13 | 7 | 240 | 34 |
| C-6 | F-6 | 8 | 7 | 166 | 23 |
| C-7 | F-7 | 7 | 4 | 173 | 43 |

### Example 3. Formulation Samples with Pigments and Fillers

Pigment or filler was added to Formulation Sample F-7 and Formulation Sample F-2 prepared in Example 1 and stirred at ˜2000 rpm using a dispersant blade until level of dispersion was measured at least 4 on Hegman scale.

TABLE 4
Formulations with Fillers

| | Formulation | | |
|---|---|---|---|
| Sample | Sample | Pigment (wt. %) | Filler (wt. %) |
| F-8 | F-7 | | Attagel (10 wt. %) |
| F-9 | F-2 | TiO₂ (43.3 wt. %) | CaCO₃ (27.7 wt. %) |

Samples F-8 and F-9 were coated on Kraft paper and dried overnight and at room temperature. Water vapor permeability was determined according to ASTM E 96, in which dry cup permeance was determined according to ASTM-E 96a and wet cut permeance was determined according and ASTM-E 96b.

TABLE 5
Water Vapor Permeability

| | | | Dry Cup | Wet Cup | Wet |
|---|---|---|---|---|---|
| Coat | | Coat | Permeance | Permeance | Cup/Dry |
| layer | Sample | weight | (US Perms) | (US Perms) | Cup ratio |
| C-8 | F-8 | 8 | 2 | 163 | 81 |
| C-9 | F-9 | 47 | 4 | 118 | 30 |

The data of Table 6 shows that filled formulations of PVA or PVA copolymers maintain desired water permeability properties, e.g., a ratio of Wet Cup Permeability to Dry Cup Permeability that is greater than 10.

### Example 4. Adhesion Testing of PVA and PVA Copolymer Formulations

Formulations Samples F-1 to F-6 from Example 1 were coated on a respective non-woven polyethylene film using #25 wired rod and then dried overnight at room temperature to produce coated samples, C-14 to C-19.

A 3×3 (5 mm pitch) crosshatch pattern was cut into coat layers (dried formulation samples F-1 to F-6)). Tape adhesion was performed by applying Permacel P99 Adhesion Tape to the crosshatch area and then pulling the Permacel P99 Adhesion Tape away from the crosshatch area. The percentage (%) of the coat layer removed from the film by the tape was reported. The smaller the percent of removed coating layer, the better its adhesion is to the film.

TABLE 6
Tape Adhesion Results

| | | Tape Adhesion |
|---|---|---|
| Coated | Formulation | (% of coat layer |
| Sample | Sample | removed from film) |
| C-14 | F-1 | 72 |
| C-15 | F-2 | 36 |
| C-16 | F-3 | 33 |
| C-17 | F-4 | 72 |
| C-18 | F-5 | 8.33 |
| C-19 | F-6 | 28 |

These results show that PVA copolymer with vinyl formamide has desired adhesion to non-woven polyethylene material.

### Example 5. Preparation and Evaluation of Crosslinked PVA-Copolymer/Polyacrylic Acid Coating

Preparation of Sample F-10:139.5 g of Formulation Sample F-5 in Example 1 was mixed with 153.6 g of 35% of aqueous solution of polyacrylic acid (Mw-250,000, Sokolan PA 110S).

Preparation of Coated Substrates (Multilayer Structures): Formulation Sample 5 and Formulation Sample 15 were each coated on a respective non-woven polyethylene film using #25 wired rod and dried overnight at room temperature, and then further dried at 250° F. for 4 hrs to produce coated substrates C-20 and C-21 (multilayer structures each having a cross-linked coat layer and substrate layer).

Dissolution testing. A sample of C-20, of C-21, and of uncoated non-woven polyethylene were each weighed and then submerged separately in beakers full of water. After 1 hour, each sample was moved in and out of water 10 times and dried overnight at room temperature. Samples were weighed again and the dry coat weight loss in water was calculated.

Tape adhesion testing: A 3×3 (5 mm pitch) crosshatch pattern was cut into the coat layers (dried formulation samples 5 and 15). Tape adhesion was performed by applying Permacel P99 Adhesion Tape to the crosshatch area and then pulling the Permacel P99 Adhesion Tape away from the crosshatch area. The percentage (%) of the coat layer removed from the film by the tape was reported. The smaller the percent of removed coating layer, the better its adhesion is to the film.

TABLE 7
Dissolution Loss and Tape Adhesion Results

| | | | Tape Adhesion |
|---|---|---|---|
| Coated | | Dissolution | (% of coating |
| Substrate | Formulation | loss (%) | removed from film) |
| C-20 | F-5 | 100% | 8.33 |
| C-21 | F-15 | 4% | 11 |

Water vapor permeability testing: Water vapor permeability was determined according to ASTM E 96, in which dry cup permeance was determined according to ASTM-E 96a and wet cut permeance was determined according and ASTM-E 96b.

TABLE 8
Water Vapor Permeability Results

| | | Wet Cap | Wet Cap |
|---|---|---|---|
| | | permeability | permeability |
| | | (D1) (US | (D2) (US |
| | Dry Cap | Perms | Perms |
| | permeability | direction in | direction in |
| Coating | (US Perms) | FIG. 1 | FIG. 1 |
| C-20 | 4 | 48 | 31 |
| C-21 | 3 | 35 | 11 |

This data shows that cross-linked coat layer C-21 has desired water resistance with minimal deterioration of adhesion and desired permeability properties.

### Example 6. Evaluation of Copper Phthalocyanine in PVA Copolymer/Polyacrylic Acid Formulations

Preparation of Sample F-16:1 g of 40% dispersion of copper phthalocyanine in water was added to Sample F-15 under stirring at 300 rpm at room temperature for 15 minutes.

Preparation of Coated Substrate (Multilayer Structure): Sample F-16 was coated on non-woven polyethylene using #25 wired rod, dried overnight at room temperature, and then dried for 4 hrs at 250° F. to produce coated substrate C-22 (multilayer structure having a cross-linked coat layer and substrate layer).

Water column experiment. A 4″ tube was attached to the surface of non-woven polyethylene film (Tyvek) and to the uncoated side of C-21 prepared in Example 8 and C-22 using hot-melt adhesive or silicone adhesive A mixture of 90% water and 10% dishwasher soap, Dawn, was poured into the tube, so that soap mixture forms a 2″ column on the top of the non-woven polyethylene or uncoated side of C-21 and C-22. Assembly was placed vertically on a support and time of first drop that penetrate through the coating was recorded.

TABLE 9
Water column experiment

| | Time for | |
|---|---|---|
| Coating | the first drop | |
| Non-woven | 0.2 | hrs |
| polyethylene | | |
| C-21 | 3 | hrs |
| C-22 | >48 | hrs |

These results demonstrate that addition of copper phthalocyanine helps in water resistance properties of PVA copolymer/polyacrylic acid coatings

### Example 7. Evaluation of Water-Resistant Coating (Crosslinkable Formulation with PVA/Vinyl Amine Copolymer and PVA/Vinyl Carboxylic Acid Copolymer)

Preparation of Sample: 37 g of Formulation Sample F-3 prepared in Example 1 was mixed with 37 g of 15% aqueous solution of PVA/vinyl carboxylic acid copolymer (Elvanol T-66) at 300 rpms at a temperature of room temperature for 30 minutes.

Preparation of Coated Substrate (Multilayer Structure). The sample was coated on non-woven polyethylene film using #25 wired rod, dried at room temperature overnight, and then cured in an oven at 250° F. for 4 hrs to produce coated substrate C-23.

Tape adhesion testing: A 3×3 (5 mm pitch) crosshatch pattern was cut into the coat layer (dried sample). Tape adhesion was performed by applying Permacel P99 Adhesion Tape to the crosshatch area and then pulling the Permacel P99 Adhesion Tape away from the crosshatch area. The percentage (%) of the coat layer removed from the film by the tape was reported. The smaller the percent of removed coating layer, the better its adhesion is to the film.

Water column experiment. A 4″ tube was attached to the surface of non-woven polyethylene film (Tyvek) and to the uncoated side of C-21 prepared in Example 8 and C-22 using hot-melt adhesive or silicone adhesive A mixture of 90% water and 10% dishwasher soap, Dawn, was poured into the tube, so that soap mixture forms a 2″ column on the top of the non-woven polyethylene or uncoated side of C-23. Assembly was placed vertically on a support and time of first drop that penetrate through the coating was recorded.

TABLE 10
Evaluation of C-23

| Test | Results |
|---|---|
| Adhesion | 7% |
| Water column | >48 hrs |
| Water Permeability | |
| Wet Cup permeability in direction | 49 |
| D1 (see FIG. 1) (US Perms) | |
| Wet Cup permeability (in direction | 18 |
| D2 (see FIG. 1) (US Perms) | |

These results show that mixture of PVA/vinyl amine copolymer and PVA/vinyl carboxylic acid forms water resistant coating on non-woven polyethylene. The resulting cross-linked coat layer has good water permeability and good adhesion to non-woven polyethylene film.

Terminology used herein is for the purpose of describing particular implementations and implementations only and is not intended to be limiting. For example, as used herein, the singular forms “a,” “an,” and “the” are intended to include the plural forms as well, unless the context clearly indicates otherwise.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

As used herein in the specification and claims, including as used in the examples and unless otherwise expressly specified, all numbers can be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. The word “about” or “approximately” when immediately preceding a numerical value means a range of plus or minus 10% of that value, e.g., “about 50” means 45 to 55, “about 25,000” means 22,500 to 27,500, etc. Furthermore, the phrases “less than about” a value or “greater than about” a value should be understood in view of the definition of the term “about” provided herein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative implementations are described above, any of a number of changes can be made to various implementations without departing from the teachings herein. For example, the order in which various described method steps are performed may often be changed in alternative implementations, and in other alternative implementations, one or more method steps may be skipped altogether. Optional features of various structures, methods, and coating composition may be included in some implementations and not in others. Therefore, the foregoing description is provided primarily for exemplary purposes and should not be interpreted to limit the scope of the claims.

The examples and illustrations included herein show, by way of illustration and not of limitation, specific implementations in which the subject matter may be practiced. As mentioned, other implementations may be utilized and derived there from, such that structural and logical substitutions and changes may be made without departing from the scope of this disclosure. Such implementations of the inventive subject matter may be referred to herein individually or collectively by the term “invention” merely for convenience and without intending to voluntarily limit the scope of this application to any single invention or inventive concept, if more than one is, in fact, disclosed. Thus, although specific implementations have been illustrated and described herein, any arrangement calculated to achieve the same purpose may be substituted for the specific implementations shown. This disclosure is intended to cover any and all adaptations or variations of various implementations. Combinations of the above implementations, and other implementations not specifically described herein, will be apparent to those of skill in the art upon reviewing the above description. Use of the term “based on,” herein and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with implementations related to the described subject matter. Although a few variations have been described in detail herein, other modifications or additions are possible. In particular, further features and/or variations can be provided in addition to those set forth herein. For example, the implementations described herein can be directed to various combinations and subcombinations of the disclosed features and/or combinations and subcombinations of several further features disclosed herein. In addition, the logic flows depicted in the accompanying figures and/or described herein do not necessarily require the particular order shown, or sequential order, to achieve desirable results. Other implementations may be within the scope of the following claims.

1. A multilayer structure comprising:
a substrate layer having a first surface and a second, opposing surface; and
a cross-linked coat layer deposited on at least a portion of the first surface of the substrate layer, the cross-linked coat layer comprising a mixture of polyvinyl alcohol and polycarboxylic acid, wherein the cross-linked coat layer has an first dry coat weight, and wherein, after the first cross-linked coat layer is exposed to water, the cross-linked coat layer has a second dry coat weight greater than 90% of the first dry coat weight;
wherein the multilayer structure is configured to promote egress of water vapor in a first direction from the cross-linked coat layer to the substrate layer when the relative humidity is greater adjacent the cross-linked coat layer than adjacent the substrate layer;
wherein the multilayer structure is configured to inhibit ingress of water vapor in a second direction from the substrate layer to the cross-linked coat layer when the relative humidity is greater adjacent the substrate layer than adjacent the cross-linked coat layer, and
wherein the multilayer structure has a first wet-cup permeance in the first direction and has a second wet-cup permeance in the second direction, the first wet-cup permeance being greater than second wet-cup permeance.

2. The multilayer structure of claim 1, wherein the polyvinyl alcohol comprises polyvinyl alcohol copolymers.

3. The multilayer structure of claim 1, wherein the polycarboxylic acid comprises one or more polycarboxylic acid copolymers.

4. The multilayer structure of claim 1, wherein the polycarboxylic acid comprises polyacrylic acid, polymaleic acid, or a combination thereof.

5.-7. (canceled)

8. The multilayer structure of claim 1, wherein the first dry coat weight is from about 3 gsm to about 50 gsm or is 10 gsm.

9. (canceled)

10. The multilayer structure of claim 1, wherein the first wet-cup permeance is at least 30 US perms.

11. The multilayer structure of claim 1, wherein the second wet-cup permeance is at most 30 US perms.

12. The multilayer structure of claim 1, wherein a ratio of the first wet-cup permeance to the second wet-cup permeance is about 3:2 or is about 2:1.

13. (canceled)

14. The multilayer structure of claim 1, wherein the multilayer structure has a dry-cup permeance from about 0.1 US perms to 10 US perms or from about 1 US perms to 10 US perms.

15. (canceled)

16. The multilayer structure of claim 1, wherein the cross-linked coat layer further comprises at least one of one or more fillers, one or more pigments, or one or more pigment extenders, one or more crosslinking agents, one or more cross-linking catalysts, one or more plasticizers, or any combination thereof.

17.-18. (canceled)

19. The multilayer structure of claim 1, wherein the substrate layer includes a desiccant material.

20. The multilayer structure of claim 1, wherein the substrate layer does not include a desiccant material.

21. The multilayer structure of claim 1, wherein the substrate layer comprises gypsum, a non-woven high-density polyethylene (HDPE) film, an open-cell insulation foam, faced insulation batts, insulation panels, a water resistive barrier film, magnesium oxide, cement, engineered wood, paper, wood fiber insulation, or any combination thereof.

22.-30. (canceled)

31. The multilayer structure of claim 1, wherein the polyvinyl alcohol and polycarboxylic acid are present within the mixture at a ratio of polyvinyl alcohol to polycarboxylic acid, wherein the ratio is about 20:1 about 10:1, about 4:1, about 2:1, about 3:2, about 1:1, about 2:3, about 1:2, about 1:4, about 1:10, or about 1:20.

32. A method of creating a multilayer structure comprising:
providing a substrate layer having a first surface and a second surface that is opposite the first surface;
depositing a coating composition on at least a portion of the first surface of the substrate layer, the coating composition comprising a carrier, polyvinyl alcohol, and polycarboxylic acid, the carrier comprising water; and
heating the coating composition to produce a cross-linked coat layer on the first surface of the substrate layer,
wherein the cross-linked coat layer has an first dry coat weight, and wherein, after the cross-linked coat layer is exposed to water, the cross-linked coat layer has a second dry coat weight greater than 90% of the first dry coat weight;
wherein the multilayer structure is configured to promote egress of water vapor in a first direction from the cross-linked coat layer to the substrate layer when the relative humidity is greater adjacent the cross-linked coat layer than adjacent the substrate layer; and
wherein the multilayer structure is configured to inhibit ingress of water vapor in a second direction from the substrate layer to the cross-linked coat layer when the relative humidity is greater adjacent the substrate layer than adjacent the cross-linked coat layer, wherein the multilayer structure has a first wet-cup permeance in the first direction and has a second wet-cup permeance in the second direction, the first wet-cup permeance being greater than second wet-cup permeance.

33.-64. (canceled)

65. A wall assembly comprising:
a wall frame having a cavity defined therein; and
one or more multilayer structures of claim 1, wherein a first multilayer structure of the one or more multilayer structures is disposed on a first face of the wall frame.

66. The wall assembly of claim 65, wherein the cross-linked layer of the first multilayer structure is positioned proximate to the cavity and the substrate layer of the first multilayer structure is positioned distal to the cavity.

67. The wall assembly of claim 66, wherein a surface of the substrate layer of the first multilayer structure is a first exterior-most surface of the wall assembly.

68. The wall assembly of claim 65, wherein a second multilayer structure of the one or more multilayer structures is disposed on a second face of the wall frame, and wherein the second face opposes the first face of the wall frame.

69. The wall assembly of claim 68, wherein the cross-linked layer of the second multilayer structure is positioned proximate to the cavity and the substrate layer of the second multilayer structure is positioned distal to the cavity.

70.-71. (canceled)
